(19) United States
(12) Patent Application Publication
(10) Pub. No.: US 2017/0362430 A1
(43) Pub. Date: Dec. 21, 2017

(54) FILLED POLYCARBONATE COMPOSITIONS HAVING IMPROVED FLOWABILITY AND GREAT RIGIDITY

(71) Applicant: Covestro Deutschland AG, Leverkusen (DE)

(72) Inventors: Helmut Werner HEUER, Leverkusen (DE); Rolf WEHRMANN, Krefeld (DE); Anke BOUMANS, Goch (DE); Michael ERKELENZ, Duisburg (DE); Hans FRANSSEN, Krefeld (DE)

(21) Appl. No.: 15/532,193

(22) PCT Filed: Nov. 26, 2015
(86) PCT No.: PCT/EP2015/077729

§ 371 Date: Jun. 1, 2017

(30) Foreign Application Priority Data
Dec. 1, 2014 (EP) 14195706.8

(51) Int. Cl. C08L 69/00

(52) U.S. Cl. CPC C08L 69/00; C08L 2205/035; C08L 2205/025; C08L 2205/03

(57) ABSTRACT

The present invention relates to glass fibre, carbon fibre and/or carbon nanotube reinforced polycarbonate compositions comprising flame retardant, diglycerol monoester and optionally antidripping agent and having high flowability, excellent stiffness and possibly improved flame retardant properties. The present invention further relates to the use of the compositions according to the invention in particular in the manufacture of housing parts in the EE and IT sector, for example for electrical housings/junction boxes or for frames of LCD/LED screens and also for component parts for the manufacture of Ultrabooks.

The present invention relates to not only glass fibre but also carbon fibre reinforced or carbon nanotube reinforced polycarbonate compositions having high flowability, excellent stiffness and possibly improved flame retardant properties. The present invention further relates to the use of the compositions according to the invention in the manufacture of housing parts in the EE and IT sector, for example for electrical housings/junction boxes or for frames of LCD/LED screens and also for housing parts of mobile communication terminals, such as smartphones, tablets, Ultrabooks, notebooks or laptops, but also satnavs, smartwatches or heart rate monitors, and also electrical applications in thin walled designs, for example residential and industrial networking systems and smart meter housing components.

These compositions are particularly useful for comparatively large component parts achieving a UL94 V-0 fire protection classification at a wall thickness of 1.5 mm.

The prior art discloses admixing plastics such as polycarbonate with glass fibres, carbon fibres or carbon nanotubes to improve stiffness. A large number of flame retardants are further known to be suitable for polycarbonate. Yet optimizing the properties of a polycarbonate with regard to stiffness and flame retardant properties entails sacrificing the flowability in particular.

WO 2013/045552 A1 describes glass fibre filled flame retardant polycarbonates having a high degree of stiffness and also good toughness. Nothing is taught about the possibility of improving the flowability of corresponding compositions. U.S. Pat. No. 3,951,903 A describes the use of carboxylic anhydrides in glass fibre filled polycarbonates to improve the stress cracking resistance. EP 0 063 769 A2 describes a polycarbonate comprising glass fibres and polyanhydride and having an improved level of impact strength. Improved flowability is not described.

Improved flow is traditionally sought by using BDP (bisphenol A diphosphate), in amounts of up to more than 10 wt %, to achieve the desired effect. Heat resistance is severely reduced as a result, however.

Diglycerol esters are cited in connection with transparent antistatic compositions, for example in JP2011108435 A, JP2010150457 A, JP2010150458 A. JP2009292962 A describes specific embodiments wherein the ester has at least 20 carbon atoms. JP2011256359 A describes flame retardant UV-stabilized antistatic compositions comprising diglycerol esters.

One problem addressed by the present invention was that of providing reinforced polycarbonate compositions featuring a combination of high stiffness, high flowability and ideally a UL94 V-0 flame resistance (for shaped articles produced with a wall thickness of 1.5 mm) and also corresponding shaped articles without the disadvantages of the prior art compositions, for example insufficient flowability during processing.

It has now been found that, surprisingly, this problem is solved by a composition comprising
A) 20.0 wt % to 99.0 wt % of an aromatic polycarbonate,
B) 0.0 wt % to 1.0 wt % of at least one flame retardant,
C) 0.5 wt % to 50.0 wt % of at least one glass fibre, one carbon fibre and/or carbon nanotubes,
D) 0.01 wt % to 3.0 wt % of at least one flow auxiliary selected from the group of diglycerol esters,
E) 0.0 wt % to 5.0 wt % of at least one antidripping agent,
F) 0.0 wt % to 1.0 wt % of at least one thermal stabilizer,
G) 0.0 wt % to 10.0 wt % of further additives.

Preferably, the composition does not contain any further components, instead the components A) to G) add up to 100 wt %.

Despite high proportions of glass fibres and/or carbon fibres and/or carbon nanotubes and further additives, relatively small amounts of the diglycerol ester are surprisingly sufficient to effect a significant improvement in flowability. Correspondingly, the influence on thermal properties, for example the heat resistance, is minimal.

The invention is further solved by shaped articles obtained from such a composition.

Those compositions according to the invention which have a melt volume flow rate MVR of 1 to 30 cm³/10 min, more preferably of 7 to 25 cm³/10 min, determined to ISO 1133 (test temperature 300° C., mass 1.2 kg), and a UL-94 V-0 flammability rating at 1.5 mm wall thickness and/or a melt volume flow rate MVR of 1 to 30 cm³/10 min, more preferably of 7 to 25 cm³/10 min, determined to ISO 1133 (test temperature 300° C., mass 1.2 kg) and—in the case of glass fibres being present in the compositions—a Charpy impact strength, determined to DIN EN ISO 179 at room temperature, of above 35 kJ/m² are preferable for use in the manufacture of shaped articles.

The compositions according to the invention are notable for good mechanical properties, in particular a good level of stiffness, and very good rheological behaviour (easy flowing) coupled with possibly improved flame resistance. The preference of the invention is for those compositions that comprise a flame retardant as well as fillers.

The individual constituents of compositions according to the invention are even more particularly described hereinbelow:

### Component A

Polycarbonates for the purposes of the present invention are not only homopolycarbonates but also copolycarbonates; the polycarbonates in question may be linear or branched in the familiar manner. Mixtures of polycarbonates are also useful according to the invention.

The polycarbonates in question are prepared from diphenols, carbonic acid derivatives, optionally terminators and branching agents in the familiar manner.

Details relating to the preparation of polycarbonates have been set down in many patent documents for about 40 years. Reference may be made here for example to Schnell, “Chemistry and Physics of Polycarbonates”, Polymer Reviews, Volume 9, Interscience Publishers, New York, London, Sydney 1964, to D. Freitag, U. Grigo, P. R. Miller, H. Nouvertné, BAYER AG, “Polycarbonates” in Encyclopedia of Polymer Science and Engineering, Volume 11, Second Edition, 1988, pages 648-718 and finally to U. Grigo, K. Kirchner and P. R. Miller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299.

Aromatic polycarbonates are prepared, for example, by reaction of diphenols with carbonyl halides, preferably phosgene, and/or with aromatic dicarbonyl dihalides, preferably benzenedicarbonyl dihalides, by the phase interface process, optionally by use of terminators and optionally by use of trifunctional or more than trifunctional branching agents. Production via a melt polymerization process by reaction of diphenols with, for example, diphenyl carbonate is likewise possible.

Useful diphenols for preparing polycarbonates include, for example, hydroquinone, resorcinol, dihydroxybiphenyls, bis(hydroxyphenyl)alkanes, bis(hydroxyphenyl)cycloalkanes, bis(hydroxyphenyl) sulphides, bis(hydroxyphenyl) ethers, bis(hydroxyphenyl) ketones, bis(hydroxyphenyl) sulphones, bis(hydroxyphenyl) sulphoxides, α,α′-bis(hydroxyphenyl)diisopropylbenzenes, phthalimidines derived from isatin or phenolphthalein derivatives and also their ring alkylated, ring arylated or ring halogenated compounds.

Preferred diphenols are 4,4′-dihydroxybiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A.

These and further suitable diphenols have been described, for example in U.S. Pat. No. 3,028,635, U.S. Pat. No. A 2 999 825, U.S. Pat. No. 3,148,172, U.S. Pat. No. 2,991,273, U.S. Pat. No. 3,271,367, U.S. Pat. No. 4,982,014 and U.S. Pat. No. A 2 999 846, in DE-A 1 570 703, DE-A 2063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986 and JP-A 105550/1986.

Homopolycarbonates utilize only one diphenol, while copolycarbonates utilize two or more diphenols.

Useful carbonic acid derivatives include, for example, phosgene and diphenyl carbonate.

Useful terminators for preparing polycarbonates include monophenols. Useful monophenols include, for example, phenol itself, alkylphenols such as cresols, p-tert-butylphenol, cumylphenol, and also mixtures thereof.

Preferred terminators are those phenols which have one or more substituents selected from C₁-C₃₀ alkyl moieties, linear or branched, preferably unsubstituted, and tert-butyl. Particularly preferred terminators are phenol, cumylphenol and/or p-tert-butylphenol.

The amount of terminator to be used is preferably in the range from 0.1 to 5 mol %, based on the number of moles of the particular diphenols used. The terminator may be admixed before, during or after the reaction with a carbonic acid derivative.

Useful branching agents include the trifunctional or more than trifunctional compounds familiar in polycarbonate chemistry, in particular those having three or more than three phenolic OH groups.

Useful branching agents include, for example, 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis-(3-methyl-4-hydroxyphenyl)-2-oxo-2,3-dihydroindole.

The amount of any branching agents used is preferably in the range from 0.05 mol % to 2.00 mol %, based on the number of moles of the particular diphenols used.

Branching agents may either be included together with the diphenols and the terminators in the initially charged aqueous alkaline phase or be admixed, dissolved in an organic solvent, before the phosgenation. The branching agents are used together with the diphenols in the case of the transesterification process.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane.

To incorporate additives, component A is preferably used in the form of powders, granules or mixtures of powders and granules.

In the case of glass fibre filled compositions, for example, it is preferable to use a mixture of the aromatic polycarbonates A1 and A2, having the following properties:

The amount of aromatic polycarbonate A1 relative to the overall amount of polycarbonate is from 25.0 to 85.0 wt %, preferably from 28.0 to 84.0 wt % and more preferably from 30.0 to 83.0 wt %, and this aromatic polycarbonate is based on bisphenol A with a preferred melt volume flow rate MVR of 7 to 15 cm³/10 min, more preferably a melt volume flow rate MVR of 8 to 12 cm³/10 min and yet more preferably a melt volume flow rate MVR of 8 to 11 cm³/10 min, determined according to ISO 1133 (test temperature 300° C., mass 1.2 kg).

The amount of pulverulent aromatic polycarbonate A2 relative to the overall amount of polycarbonate is from 3.0 to 12.0 wt %, preferably from 4.0 to 11.0 wt % and more preferably from 3.0 to 10.0 wt %, and this aromatic polycarbonate is preferably based on bisphenol A with a preferred melt volume flow rate MVR of 3 to 8 cm³/10 min, more preferably a melt volume flow rate MVR of 4 to 7 cm³/10 min and yet more preferably a melt volume flow rate MVR of 6 cm³/10 min, determined according to ISO 1133 (test temperature 300° C., mass 1.2 kg).

### Component B

The amount of flame retardant in the compositions of the present invention is preferably in the range from 0.001 to 1.0 wt %, more preferably in the range from 0.05 to 0.80 wt %, yet more preferably in the range from 0.10 to 0.60 wt % and most preferably in the range from 0.10 to 0.40 wt %.

Suitable flame retardants for the purposes of the present invention include alkali and/or alkaline earth metal salts of aliphatic/aromatic sulphonic acid and sulphonamide derivatives.

Salts for possible inclusion in the compositions of the present invention are: sodium perfluorobutanesulphate, potassium perfluorobutanesulphate, sodium perfluoromethanesulphonate, potassium perfluoromethanesulphonate, sodium perfluorooctanesulphate, potassium perfluorooctanesulphate, sodium 2,5-dichlorobenzenesulphate, potassium 2,5-dichlorobenzenesulphate, sodium 2,4,5-trichlorobenzenesulphate, potassium 2,4,5-trichlorobenzenesulphate, sodium methylphosphonate, potassium methylphosphonate, sodium (2-phenylethylene)phosphonate, potassium (2-phenylethylene)phosphonate, sodium pentachlorobenzoate, potassium pentachlorobenzoate, sodium 2,4,6-trichlorobenzoate, potassium 2,4,6-trichlorobenzoate, sodium 2,4-dichlorobenzoate, potassium 2,4-dichlorobenzoate, lithium phenylphosphonate, sodium diphenyl sulphone sulphonate, potassium diphenyl sulphone sulphonate, sodium 2-formylbenzenesulphonate, potassium 2-formylbenzenesulphonate, sodium (N-benzenesulphonyl)benzenesulphonamide, potassium (N-benzenesulphonyl)benzenesulphonamide, trisodium hexafluoroaluminate, tripotassium hexafluoroaluminate, disodium hexafluorotitanate, dipotassium hexafluorotitanate, disodium hexafluorosilicate, dipotassium hexafluorosilicate, disodium hexafluorozirconate, dipotassium hexafluorozirconate, sodium pyrophosphate, potassium pyrophosphate, sodium metaphosphate, potassium metaphosphate, sodium tetrafluoroborate, potassium tetrafluoroborate, sodium hexafluorophosphate, potassium hexafluorophosphate, sodium phosphate, potassium phosphate, lithium phosphate, sodium nonafluoro-1-butanesulphonate, potassium nonafluoro-1-butanesulphonate or mixtures thereof.

Preference is given to using sodium perfluorobutanesulphate, potassium perfluorobutanesulphate, sodium perfluorooctanesulphate, potassium perfluorooctanesulphate, sodium diphenyl sulphone sulphonate, potassium diphenyl sulphone sulphonate, sodium 2,4,6-trichlorobenzoate, potassium 2,4,6-trichlorobenzoate. Very particular preference is given to potassium nonafluoro-1-butanesulphonate or sodium diphenyl sulphone sulphonate or potassium diphenyl sulphone sulphonate. Potassium nonafluoro-1-butanesulphonate is commercially available, inter alia as Bayowet®C4 (from Lanxess, Leverkusen, Germany, CAS No. 29420-49-3), RM64 (from Miteni, Italy) or as 3M™ perfluorobutanesulphonyl fluoride FC-51 (from 3M, USA). Mixtures of the recited salts are likewise suitable.

### Component C

Compositions according to the present invention comprise from 0.50 to 50.0 wt % of glass fibres, carbon fibres and/or carbon nanotubes, preferably from 0.50 to 45.0 wt %, more preferably from 1.0 to 38.0 wt % and yet more preferably from 1.0 to 35.0 wt %.

### Glass Fibres:

The glass fibres consist of a glass composition selected from the group of M-, E-, A-, S-, R-, AR-, ECR-, D-, Q- or C-glasses, of which E-, S- or C-glass is preferred.

The glass composition is preferably used in the form of solid glass spheres, hollow glass spheres, glass beads, glass flakes, cullet as well as glass fibres, of which glass fibres are further preferable.

Glass fibres may be used in the form of continuous filament fibres (rovings), chopped glass fibres, ground fibres, glass fibre fabrics or mixtures thereof, in which case the chopped glass fibres and also the ground fibres are used with preference.

Chopped glass fibres are used with particular preference.

Chopped glass fibres precompounding length is preferably in the range from 0.5 to 10 mm, more preferably in the range from 1.0 to 8 mm and most preferably in the range from 1.5 to 6 mm.

The chopped glass fibres used may have different cross sections. Round, elliptical, oval, octagonal and flat cross sections are used with preference, while the round, oval and also flat cross sections are particularly preferable.

Round fibre diameter is preferably in the range from 5 to 25 μm, more preferably in the range from 6 to 20 μm and yet more preferably in the range from 7 to 17 μm.

Preferred flat and oval glass fibres have a height-to-width cross-sectional ratio of about 1.0:1.2 to 1.0:8.0, preferably 1.0:1.5 to 1.0:6.0, more preferably 1.0:2.0 to 1.0:4.0.

Flat and oval glass fibres preferably have an average fibre height of 4 μm to 17 μm, more preferably of 6 μm to 12 μm and yet more preferably of 6 μm to 8 μm and also an average fibre width of 12 μm to 30 μm, more preferably of 14 μm to 28 μm and yet more preferably of 16 μm to 26 μm.

The glass fibres may be glass fibres surface modified with a glass size. Preferred glass sizes are epoxy modified, polyurethane modified and unmodified silane compounds and also mixtures thereof.

The glass fibres may also not be modified with a glass size.

A feature of the glass fibres used is that the selection of the fibre is not constrained by the manner in which the fibre interacts with the polycarbonate matrix.

An improvement in those properties of the compositions which are according to the invention is obtained not only for strong coupling to the polymer matrix but also for a non-coupling fibre.

Any coupling of the glass fibre to the polymer matrix will be apparent from the low temperature fracture surfaces in scanning electron micrographs, in that most of the glass fibres which have broken will have broken at the same height as the matrix and there will only be isolated glass fibres protruding from the matrix. In the opposite case of non-coupling characteristics, what scanning electron micrographs show is that in low temperature fracture the glass fibres protrude markedly from the matrix or have completely slipped out therefrom.

When glass fibres are present, the glass fibre content of the composition is more preferably in the range from 10 to 35 wt % and yet more preferably in the range from 10 to 30 wt %.

### Carbon Fibres:

Carbon fibres are industrially manufactured from precursors such as, for example, acrylic fibres by pyrolysis (carbonization). A distinction is made between filament yarn and short fibres.

The compositions of the present invention preferably utilize short fibres.

Chopped fibre length is preferably between 3 mm and 125 mm. Fibres from 3 mm to 25 mm in length are used with particular preference.

Fibres of cubic dimension (platelet shaped) are usable as well as fibres of round cross section.

Suitable dimensions are for example 2 mm×4 mm×6 mm.

Ground carbon fibres are usable as well as chopped fibres. Ground carbon fibres are preferably from 50 μm to 150 μm in length.

Carbon fibres optionally have coatings of organic sizes in order to enable special coupling bonds to the polymer matrix.

Short cut fibres and ground carbon fibres are typically added to the polymeric base materials by compounding.

Specific technical processes are used to arrange carbon in the form of very fine threads. These filaments are typically from 3 to 10 μm in diameter. The filaments can also be used to produce rovings, wovens, nonwovens, bands, tapes, ligaments, hoses or the like.

When the compositions comprise carbon fibres, their carbon fibre content is preferably in the range from 10 to 30 wt %, more preferably in the range from 10 to 20 wt % and yet more preferably in the range from 12 to 20 wt %.

### Carbon Nanotubes

Carbon nanotubes, also known as CNT, for the purposes of the invention are any single- or multi-walled carbon nanotubes of the cylinder type, of the scroll type or of onion-like structure. Preference is given to using multi-walled carbon nanotubes of the cylinder type, scroll type or mixtures thereof.

Carbon nanotubes are preferably used in an amount of 0.1 to 10 wt %, more preferably in an amount of 0.5 to 8 wt %, yet more preferably in an amount of 0.75 to 6 wt % and most preferably in an amount of 1 to 5 wt % (based on the overall weight of components A, B, C and D). In masterbatches, the concentration of carbon nanotubes is optionally greater and may be up to 80 wt %.

Particular preference is given to using carbon nanotubes having a length-to-outside diameter ratio of above 5, preferably above 40.

Carbon nanotubes are used with particular preference in the form of agglomerates the average diameter of said agglomerates being in particular in the range from 0.01 to 5 mm, preferably from 0.05 to 2 mm and more preferably 0.1-1 mm.

It is particularly preferred for the carbon nanotubes to be used to have essentially an average diameter of 3 to 100 nm, preferably 5 to 80 nm, more preferably 6 to 60 nm.

### Component D

The employed flow auxiliaries D are esters of carboxylic acids with diglycerol. Diglycerol esters based on various carboxylic acids are suitable. The esters may also be based on different isomers of diglycerol. Polyesters of diglycerol are usable as well as monoesters. Mixtures are usable as well as pure compounds.

The following isomers of diglycerol form the basis for the diglycerol esters used according to the present invention:

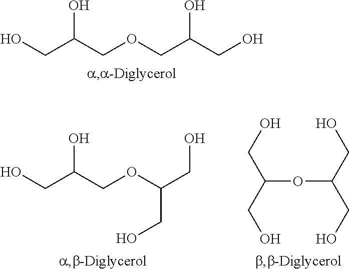 [SMILES: OCC(O)COCC(O)CO ; OCC(O)COC(CO)CO ; OCC(CO)OC(CO)CO]

The diglycerol esters used according to the present invention may utilize those isomers of these formulae which are mono- or polyesterified. Mixtures usable as flow auxiliaries consist of the starting diglycerol materials as well as the ester end products derived therefrom, for example with the molecular weight of 348 g/mol (monolauryl ester) or 530 g/mol (dilauryl ester).

The diglycerol esters present in the composition in the manner of the present invention preferably derive from saturated or unsaturated monocarboxylic acids having a chain length of 6 to 30 carbon atoms. Useful monocarboxylic acids include, for example, caprylic acid (C₇H₁₅COOH, octanoic acid), capric acid (C₉H₁₉COOH, decanoic acid), lauric acid (C₁₁H₂₃COOH, dodecanoic acid), myristic acid (C₁₃H₂₇COOH, tetradecanoic acid), palmitic acid (C₁₅H₃₁COOH, hexadecanoic acid), margaric acid (C₁₆H₃₃COOH, heptadecanoic acid), stearic acid (C₁₇H₃₅COOH, octadecanoic acid), arachidic acid (C₁₉H₃₉COOH, cicosanoic acid), behenic acid (C₂₁H₄₃COOH, docosanoic acid), lignoceric acid (C₂₃H₄₁COOH, tetracosanoic acid), palmitoleic acid (C₁₅H₂₉COOH, (9Z)-hexadeca-9-enoic acid), petroselic acid (C₁₇H₃₃COOH, (6Z)-octadeca-6-enoic acid), elaidic acid (C₁₇H₃₃COOH, (9E)-octadeca-9-enoic acid), linoleic acid (C₁₇H₃₁COOH, (9Z,12Z)-octadeca-9,12-dienoic acid), alpha- or gamma-linolenic acid (C₁₇H₂₉COOH, (9Z,12Z,15Z)-octadeca-9,12,15-trienoic acid and (6Z,9Z,12Z)-octadeca-6,9,12-trienoic acid), arachidonic acid (C₁₉H₃₁COOH, (5Z,8Z,11Z,14Z)-eicosa-5,8,11,14-tetraenoic acid), timnodonic acid (C₁₉H₂₉COOH, (5Z,8Z,11Z,14Z,17Z)-eicosa-5,8,11,14,17-pentaenoic acid) and cervonic acid (C₂₁H₃₁COOH, (4Z,7Z,10Z,13Z,16Z,19Z)-docosa-4,7,10,13,16,19-hexaenoic acid). Lauric acid, palmitic acid and/or stearic acid are particularly preferable.

The diglycerol ester content is more preferably at least one ester of formula (I)

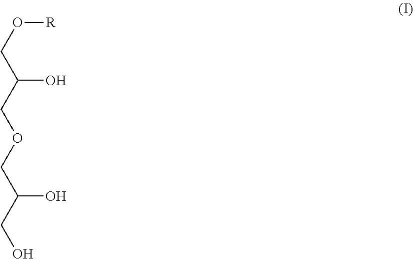

where R=COCₙH₂ₙ₊₁ and/or R═COR′,
where n is an integer and where R′ is a branched alkyl moiety or a branched or unbranched alkenyl moiety and CₙH₂ₙ₊₁ is an aliphatic, saturated linear alkyl moiety.

Here n is preferably an integer from 6-24, so CₙH₂ₙ₊₁ is for example n-hexyl, n-heptyl, n-octyl, n-nonyl, n-decyl, n-dodecyl, n-tridecyl, n-tetradecyl, n-hexadecyl or n-octadecyl. It is further preferable for n to be from 8 to 18, more preferably from 10 to 16 and most preferably 12 (diglycerol monolaurate isomer of molecular weight 348 g/mol, which is particularly preferable as the principal product in a mixture). The aforementioned ester groups are for the purposes of the present invention preferably also present in the other isomers of diglycerol.

So a mixture of various diglycerol esters may also be concerned.

Preferably employed diglycerol esters have an HLB value of at least 6, more preferably 6 to 12, the HLB value referring to the “hydrophilic-lipophilic balance” which, by the method of Griffin, is computed as follows:

HLB=20×(1−Mₗᵢₚₒₚₕᵢₗₑ/M),

where Mₗᵢₚₒₚₕᵢₗₑ is the molar mass of the lipophilic portion of the diglycerol ester, and M is the molar mass of the diglycerol ester.

The amount of diglycerol ester is from 0.01 to 3.0 wt %, preferably from 0.10 to 2.0 wt %, more preferably from 0.15 to 1.50 wt/o and most preferably from 0.20 to 1.0 wt %.

### Component E

The compositions of the present invention preferably comprise an antidripping agent. The amount of antidripping agent is preferably from 0.05 to 5.0 wt %, more preferably from 0.10 wt % to 2.0 wt % and yet more preferably 0.10 wt % to 1.0 wt % of at least one antidripping agent.

By way of antidripping agent, polytetrafluoroethylene (PTFE) is preferably added to the compositions. PTFE is commercially available in various product grades. These include Hostaflon® TF2021 or else PTFE blends such as Metablen® A-3800 (about 40 wt % of PTFE, CAS 9002-84-0 and about 60 wt % of methyl methacrylate/butyl acrylate copolymer CAS 25852-37-3, from Mitsubishi-Rayon) or Blendex® B449 (about 50 wt % of PTFE and about 50 wt % of SAN [from 80 wt % of styrene and 20 wt % of acrylonitrile]) from Chemtura. The use of Blendex® B449 is preferred.

### Component F

Thermal stabilizers used are preferably selected from triphenylphosphine, tris(2,4-di-tert-butylphenyl) phosphite (Irgafos® 168), tetrakis(2,4-di-tert-butylphenyl) [1,1-biphenyl]-4,4′-diylbisphosphonite, trisisooctyl phosphate, octadecyl 3-(3,5-di-tert-butyl-4-hydroxyphenyl)propionate (Irganox® 1076), bis(2,4-dicumylphenyl)pentaerythritol diphosphite (Doverphos® S-9228), bis(2,6-di-tert-butyl-4-methylphenyl)pentaerythritol diphosphite (ADK STAB PEP-36). They are used singly or mixed (e.g. Irganox® B900 (mixture of Irgafos® 168 and Irganox® 1076 μm a ratio of 1:3) or Doverphos® S-9228 with Irganox® B900 and/or Irganox® 1076). Thermal stabilizers are preferably employed in amounts of 0.003 to 0.2 wt %.

### Component G

Optionally up to 10.0 wt %, preferably from 0.10 to 8.0 wt % and more preferably from 0.2 to 3.0 wt % of other customary additives (“further additives”) are present in addition. The group of further additives includes no flame retardants, no antidripping agents and no thermal stabilizers, since these are already described as components B, E and F. The group of further additives also includes no glass fibres nor carbon fibres nor carbon nanotubes, since these are already captured in group C. “Further additives” are also not flow auxiliaries from the group of diglycerol esters, since these are already captured as component D.

Such additives as are typically added in the case of polycarbonates are particularly the antioxidants, UV absorbers, IR absorbers, antistats, optical brighteners, light scattering agents, colorants such as pigments, including inorganic pigments, carbon black and/or dyes, inorganic fillers such as titanium dioxide or barium sulphate as are described in EP-A 0 839 623, WO-A 96/15102, EP-A 0 500 496 or “Plastics Additives Handbook”, Hans Zweifel, 5th Edition 2000, Hanser Verlag, Munich, in the amounts customary for polycarbonate. These additives may be added singly or else mixed.

Preferred additives are specific UV stabilizers, which have a very low transmission below 400 nm and a very high transmission above 400 nm. Particularly suitable ultraviolet absorbers for use in the composition of the present invention are benzotriazoles, triazines, benzophenones and/or arylated cyanoacrylates.

Particularly suitable ultraviolet absorbers are hydroxybenzotriazoles, such as 2-(3′,5′-bis(1,1-dimethylbenzyl)-2′-hydroxyphenyl)benztriazole (Tinuvin® 234, BASF, Ludwigshafen), 2-(2′-hydroxy-5′-(tert-octyl)phenyl)benzotriazole (Tinuvin® 329, BASF, Ludwigshafen), bis(3-(2H-benzotriazolyl)-2-hydroxy-5-tert-octyl)methane (Tinuvin® 360, BASF, Ludwigshafen), 2-(4,6-diphenyl-1,3,5-triazin-2-yl)-5-(hexyloxy)phenol (Tinuvin® 1577, BASF, Ludwigshafen), and also benzophenones such as 2,4-dihydroxybenzophenone (Chimasorb® 22, BASF, Ludwigshafen) and 2-hydroxy-4-(octyloxy)benzophenone (Chimassorb® 81, BASF, Ludwigshafen), 2,2-bis[[(2-cyano-1-oxo-3,3-diphenyl-2-propenyl)oxy]methyl]-1,3-propandiyl ester (9CI) (Uvinul® 3030, BASF AG Ludwigshafen), 2-[2-hydroxy-4-(2-ethylhexyl)oxy]phenyl-4,6-di(4-phenyl)phenyl-1,3,5-triazine (Tinuvin® 1600, BASF, Ludwigshafen), tetraethyl 2,2′-(1,4-phenylenedimethylidene)bismalonate (Hostavin® B-Cap, Clariant AG) or N-(2-ethoxyphenyl)-N′-(2-ethylphenyl)ethanediamide (Tinuvin® 312, CAS No. 23949-66-8, BASF, Ludwigshafen).

Particularly preferred specific UV stabilizers are Tinuvin® 360, Tinuvin® 329 and/or Tinuvin® 312, very particular preference being given to Tinuvin® 329 and Tinuvin® 312.

Mixtures of these ultraviolet absorbers are also employable.

The composition preferably comprises ultraviolet absorbers at up to 0.8 wt %, preferably at from 0.05 wt % to 0.5 wt % and more preferably at from 0.1 wt % to 0.4 wt %, relative to the overall composition.

The composition is preferably free from additional demoulding agents.

It is particularly preferable for at least one thermal stabilizer (component F) and, optionally, as further additive, a UV absorber to be present when glass fibres are used as filler.

The polymer compositions of the present invention, comprising components A to D, optionally no B and optionally E to G, are produced using commonplace methods of incorporation, by combining, mixing and homogenizing the individual constituents, especially the homogenization being preferably carried out in the melt by application of shearing forces. The pre melt homogenization combining and mixing is optionally effected by use of pulverulent pre-mixes.

Pre-mixes of granules or granules and powders with components B to G are also usable.

Also usable are pre-mixes formed from solutions of the mixing components in suitable solvents, in which case it is optionally possible to homogenize in solution and to remove the solvent thereafter.

More particularly, components B to G of the composition according to the present invention are incorporable in the polycarbonate by familiar methods or as a masterbatch.

The use of masterbatches to incorporate the components B to G—singly or mixed—is preferable.

In this context, the composition according to the present invention can be combined, mixed, homogenized and subsequently extruded in customary apparatus such as screw extruders (ZSK twin-screw extruders for example), kneaders or Brabender or Banbury mills. After extrusion, the extrudate may be chilled and comminuted. It is also possible to pre-mix individual components and then to add the remaining starting materials singly and/or likewise mixed.

The combining and commixing of a pre-mix in the melt may also be effected in the plasticizing unit of an injection moulding machine. In this case, the melt is directly converted into a shaped article in a subsequent step.

The shaped plastics articles are preferably produced by injection moulding.

Compositions according to the invention which are in the form of polycarbonate compositions are useful in the manufacture of multilayered systems. This involves the polycarbonate composition of the present invention being applied in one or more layers atop a moulded plastic article.

Application, for example by foil insert moulding, coextrusion or multicomponent injection moulding, may be carried out at the same time as or immediately after the moulding of the shaped article. However, application may also be to the ready-shaped main body, for example by lamination with a film, by encapsulative overmoulding of an existing moulding or by coating from a solution.

Compositions according to the present invention are useful in the manufacture of frame component parts in the EE (electrical/electronic) and IT sectors, in particular for applications having high flame retardant requirements. Such applications include, for example, screens or housings, for instance for Ultrabooks or frames for LED display technologies, e.g. OLED displays or LCD displays or else for E-ink devices. Further applications are housing parts of mobile communication terminals, such as smartphones, tablets, Ultrabooks, notebooks or laptops, but also satnavs, smartwatches or heart rate monitors, and also electrical applications in thin walled designs, for example residential and industrial networking systems and smart meter housing components.

Compositions according to the present invention are used with preference to produce Ultrabooks.

Compositions according to the present invention are particularly useful in the manufacture of thin walled shaped articles 0.1 to 3 mm in thickness for the electrical/electronics sector or the IT sector with a UL-94 V-0 flammability rating at 1.5 mm wall thickness.

Particularly preferred compositions according to the present invention consist of
A) 20 wt % to 99.0 wt % of an aromatic polycarbonate,
B) 0.0 wt %/o to 1.0 wt % of at least one flame retardant selected from the group sodium perfluorobutanesulphate, potassium perfluorobutanesulphate, sodium perfluoromethanesulphonate, potassium perfluoromethanesulphonate, sodium perfluorooctanesulphate, potassium perfluorooctanesulphate, sodium 2,5-dichlorobenzenesulphate, potassium 2,5-dichlorobenzenesulphate, sodium 2,4,5-trichlorobenzenesulphate, potassium 2,4,5-trichlorobenzenesulphate, sodium methylphosphonate, potassium methylphosphonate, sodium (2-phenylethylene)phosphonate, potassium (2-phenylethylene)phosphonate, sodium pentachlorobenzoate, potassium pentachlorobenzoate, sodium 2,4,6-trichlorobenzoate, potassium 2,4,6-trichlorobenzoate, sodium 2,4-dichlorobenzoate, potassium 2,4-dichlombenzoate, lithium phenylphosphonate, sodium diphenyl sulphone sulphonate, potassium diphenyl sulphone sulphonate, sodium 2-formylbenzenesulphonate, potassium 2-formylbenzenesulphonate, sodium (N-benzenesulphonyl)benzenesulphonamide, potassium (N-benzenesulphonyl)benzenesulphonamide, trisodium hexafluoroaluminate, tripotassium hexafluoroaluminate, disodium hexafluorotitanate, dipotassium hexafluorotitanate, disodium hexafluorosilicate, dipotassium hexafluorosilicate, disodium hexafluorozirconate, dipotassium hexafluorozirconate, sodium pyrophosphate, potassium pyrophosphate, sodium metaphosphate, potassium metaphosphate, sodium tetrafluoroborate, potassium tetrafluoroborate, sodium hexafluorophosphate, potassium hexafluorophosphate, sodium phosphate, potassium phosphate, lithium phosphate, sodium nonafluoro-1-butanesulphonate, potassium nonafluoro-1-butanesulphonate or mixtures thereof.
C) 0.5 wt % to 50.0 wt % of at least one glass fibre, one carbon fibre and/or carbon nanotubes,
D) 0.01 wt % to 3.0 wt % of at least one flow auxiliary selected from the group of diglycerol esters, preferably one of formula (I), most preferably diglycerol monolauryl ester,
E) 0.0 wt % to 5.0 wt % of at least one antidripping agent,
F) 0.0 wt % to 1.0 wt % of at least one thermal stabilizer,
G) 0.0 wt % to 10.0 wt % of further additives selected from the group of UV absorbers, IR absorbers, colorants, carbon black and/or inorganic fillers.

These compositions most preferably comprise at least one glass fibre and it is even more preferable for glass fibre only to be present as reinforcing fibre.

As an alternative, it is very particularly preferable for these compositions to comprise a carbon fibre, and it is yet even further preferable for carbon fibre only to be present as reinforcing fibre.

### EXAMPLES

### 1. Description of Raw Materials and Test Methods

The polycarbonate compositions of the present invention are produced on customary machines, for example multiscrew extruders, by compounding, with or without admixture of additives and other added substances, at temperatures between 280° C. and 360° C.

The compounds of the present invention which relate to the examples hereinbelow were produced on a BerstorffZE 25 extruder at a throughput of 10 kg/h. Melt temperature was 275° C.

A base polycarbonate A utilized mixtures of components A-1, A-2, A-3, A-4, A-6 and/or A-7.

Component A-1: Linear polycarbonate based on bisphenol A having a melt volume flow rate MVR of 9.5 cm³/10 min (as per ISO 1133 at a test temperature of 300° C. and 1.2 kg loading).

Component A-2: Linear polycarbonate powder based on bisphenol A having a melt volume flow rate MVR of 6 cm³/10 min (as per ISO 1133 at a test temperature of 300° C. and 1.2 kg loading).

Component A-3: Linear polycarbonate based on bisphenol A having a melt volume flow rate MVR of 12.5 cm³/10 min (as per ISO 1133 at a test temperature of 300° C. and 1.2 kg loading).

Component A-4: Linear polycarbonate based on bisphenol A having a melt volume flow rate MVR of 6 cm³/10 min (as per ISO 1133 at a test temperature of 300° C. and 1.2 kg loading).

Component A-6: Powder of a linear polycarbonate based on bisphenol A having a melt volume flow rate MVR of 19 cm³/10 min (as per ISO 1133 at a test temperature of 300° C. and 1.2 kg loading).

Component A-7: Linear polycarbonate based on bisphenol A having a melt volume flow rate MVR of 19 cm³/10 min (as per ISO 1133 at a test temperature of 300° C. and 1.2 kg loading).

Component B: Potassium perfluoro-1-butanesulphonate, commercially available as Bayowet® C4 from Lanxess, Leverkusen, Germany, CAS No. 29420-49-3.

Component C-1: CS108F-14P chopped short glass fibres (noncoupling) from 3B having an average fibre diameter of 14 m and an average fibre length of 4.0 mm prior to compounding.

Component C-2: CS 7942 chopped short glass fibres (coupling) from Lanxess AG having an average fibre diameter of 14 μm and an average fibre length of 4.5 mm prior to compounding.

Component C-3: CF Tenax A HT C493, chopped carbon fibre from Toho Tenax Europe GmbH Germany with thermoplastic sizing and with an average chopped length of 6 mm prior to compounding.

Component C-4: Baytubes C150 HP, agglomerates of multiwall carbon nanotubes with low outside diameter, narrow diameter distribution and ultrahigh length to diameter ratio. Number of walls: 3-15/outside diameter 13-16 nm/outside diameter distribution: 5-20 nm/length: 1 to >10 μm/inside diameter: 4 nm/inside diameter distribution: 2-6 nm.

Component C-5: AC 3101 chopped carbon fibre from Dow Aksa (Turkey) with an average length of 6 mm prior to compounding.

Component C-6: Tairyfil CS2516 chopped carbon fibre from Formosa Plastic Corporation Taiwan with an average length of 6 mm prior to compounding.

Component C-7: CS Special 7968 chopped glass fibre from Lanxess AG with an average fibre diameter of 11 μm and an average fibre length of 4.5 mm prior to compounding.

Component C-8: CSG 3PA-830 chopped flat glass fibre from Nittobo with a thickness/length ratio of 1:4.

Component C-9: MF7980 ground glass fibre from Lanxess. Unsized E-glass having a fibre thickness of 14 μm and an average fibre length of 190 μm.

Component D: Poem DL-100 (diglycerol monolaurate) from Riken Vitamin as flow auxiliary.

Component E: Polytetrafluoroethylene (Blendex® B449 (about 50 wt % of PTFE and about 50 wt % of SAN [from 80 wt % of styrene and 20 wt % of acrylonitrile] from Chemtura).

Component F: triisooctylphosphate (TOF) from Lanxess AG.

Component G-1: glycerol monostearate (GMS) from Emery Oleochemicals.

Component G-2: pentaerythritol tetrastearate (PETS) from Emery Oleochemicals.

Component G-3: Elvaloy 1820 AC; ethylene-methyl acrylate copolymer from Dupont.

Charpy impact strength was measured to ISO 7391/179 eU at room temperature on single side gate injection moulded test bars measuring 80×10×4 mm.

The Charpy notched impact strength was measured to ISO 7391/179A at room temperature on single side gate injection moulded test bars measuring 80×10×3 mm.

As a measure of heat resistance the Vicat softening temperature VST/B50 was determined according to ISO 306 on 80×10×4 mm test specimens with a needle load of 50 N and a heating rate of 50° C./h using a Coesfeld Eco 2920 instrument from Coesfeld Materialtest.

UL94 V flammability was measured on bars measuring 127×12.7×1.0 mm, 127×12.7×1.5 mm and 127×12.7×3 mm. Fire class was determined by performing five tests in each case, initially after storage for 48 h at 23° C. and then after storage for 7 days at 70° C.

UL94-5V flammability was measured on bars measuring 127×12.7×1.5 mm, 127×12.7×2.0 mm and 127×12.7×3.0 mm and also on sheets measuring 150×105×1.5 mm, 150×105×2.0 mm, 150×105×3.0 mm.

The modulus of elasticity was measured to ISO 527 on single side gate injection moulded shoulder bars having a core measuring 80×10×4 mm.

Melt viscosities were determined to ISO 11443 (cone-plate arrangement).

The melt volume flow rate (MVR) was determined to ISO 1133 (at a test temperature of 300° C., mass 1.2 kg) using a Zwick 4106 from Zwick Roell.

### 2. Compositions

TABLE 1a
Inventive compositions comprising glass fibres and
Comparative Examples 1V and 4V

| Example | | 1V | 2 | 3 | 4V | 5 | 6 |
|---|---|---|---|---|---|---|---|
| A-1 | [wt %] | 79.35 | 79.35 | 79.35 | 70 | 70 | 70 |
| A-2 | [wt %] | 3.65 | 3.65 | 3.65 | 3 | 3 | 3 |
| A-2 powder | [wt %] | 6.29 | 6.09 | 5.89 | 6.29 | 6.09 | 5.89 |
| B | [wt %] | 0.2 | 0.2 | 0.2 | 0.2 | 0.2 | 0.2 |
| C-1 | [wt %] | 10 | 10 | 10 | — | — | — |
| C-2 | [wt %] | — | — | — | 20 | 20 | 20 |
| F | [wt %] | 0.01 | 0.01 | 0.01 | 0.01 | 0.01 | 0.01 |
| D | [wt %] | — | 0.2 | 0.4 | — | 0.2 | 0.4 |
| E | [wt %] | 0.5 | 0.5 | 0.5 | 0.5 | 0.5 | 0.5 |
| MVR | [cm³/10 min] | 5.5 | 10.8 | 16.1 | 4.8 | 10.3 | 20.8 |
| VST/B50 | [° C.] | 148 | 144.9 | 141.7 | 149.3 | 146.2 | 143.2 |
| Charpy impact | [kJ/m²] | 193 | 149 | 111 | 48 | 59 | 56 |
| strength at RT | | | | | | | |
| Modulus of | [N/mm²] | 3933 | 4080 | 4147 | 5869 | 6062 | 6194 |
| elasticity | | | | | | | |
| UL 94 V | | V0 | V0 | V0 | V0 | V0 | V0 |
| 1.5 mm | | | | | | | |
| Assessment | | | | | | | |

Table 1a reports important properties of Inventive Compositions 2, 3, 5 and 6. Comparative Examples 1V and 4V are presented in juxtaposition. The table reveals that the compositions of the comparative examples, which do not contain any diglycerol ester, have distinctly worse melt volume flow rates MVR.

The inventive compositions surprisingly not only display the appreciable improvement in melt volume flow rate and the improvement in melt viscosity but also an increase in the modulus of elasticity (stiffness).

TABLE 1b
Inventive compositions comprising glass fibres, FR additive
and Comparative Examples 7V and 10V
The melt viscosity values are each reported in the table
hereinbelow together with the shear rates in [1/sec].

| Example | | 7V | 8 | 9 | 10V | 11 | 12 |
|---|---|---|---|---|---|---|---|
| A-1 | [wt %] | 70 | 70 | 70 | 70 | 70 | 70 |
| A-4 | [wt %] | 3.00 | 3.00 | 3.00 | 3.00 | 3.00 | 3.00 |
| A-2 | [wt %] | 6.29 | 6.09 | 5.89 | 6.31 | 6.1 | 5.9 |
| C-2 | [wt %] | 20 | 20 | 20 | 20 | 20 | 20 |
| B | [wt %] | 0.2 | 0.2 | 0.2 | 0.2 | 0.2 | 0.2 |
| E | [wt %] | 0.5 | 05 | 0.5 | 0.5 | 0.5 | 0.5 |
| D | [wt %] | — | 0.2 | 0.4 | — | 0.2 | 0.4 |
| F | [wt %] | 0.01 | 0.01 | 0.01 | — | — | — |
| Tests: | | | | | | | |
| MVR | [ml/10 min] | 4.8 | 11.1 | 17.6 | 4.7 | 10.2 | 19.4 |
| IMVR20′ | [ml/10 min] | 4.8 | 11.9 | 19.7 | 4.9 | 12.1 | 20.8 |
| Melt viscosity at 300° C. | | | | | | | |
| eta 50 | [Pas] | 782 | 431 | 294 | 667 | 379 | 286 |
| eta 100 | [Pas] | 672 | 375 | 260 | 627 | 346 | 254 |
| eta 200 | [Pas] | 583 | 326 | 220 | 542 | 303 | 212 |
| eta 500 | [Pas] | 454 | 265 | 175 | 425 | 252 | 168 |
| eta 1000 | [Pas] | 350 | 216 | 147 | 329 | 210 | 143 |
| eta 1500 | [Pas] | 291 | 186 | 129 | 279 | 181 | 128 |
| eta 5000 | [Pas] | 152 | 109 | 79 | 141 | 102 | 77 |
| Melt viscosity at 320° C. | | | | | | | |
| eta 50 | [Pas] | 413 | 195 | 141 | 269 | 166 | 124 |
| eta 100 | [Pas] | 375 | 177 | 130 | 244 | 153 | 112 |
| eta 200 | [Pas] | 336 | 157 | 114 | 214 | 135 | 98 |
| eta 500 | [Pas] | 277 | 134 | 92 | 182 | 109 | 80 |
| eta 1000 | [Pas] | 229 | 115 | 79 | 153 | 95 | 67 |
| eta 1500 | [Pas] | 197 | 101 | 73 | 138 | 87 | 62 |
| eta 5000 | [Pas] | 109 | 65 | 52 | 83 | 58 | 44 |
| Melt viscosity at 340° C. | | | | | | | |
| eta 50 | [Pas] | 199 | 111 | — | 199 | 95 | — |
| eta 100 | [Pas] | 185 | 104 | 83 | 184 | 90 | — |
| eta 200 | [Pas] | 162 | 92 | 77 | 160 | 86 | 61 |
| eta 500 | [Pas] | 137 | 78 | 65 | 131 | 74 | 54 |
| eta 1000 | [Pas] | 120 | 70 | 54 | 112 | 65 | 48 |
| eta 1500 | [Pas] | 109 | 66 | 49 | 102 | 59 | 44 |
| eta 5000 | [Pas] | 70 | 46 | 36 | 67 | 42 | 32 |
| Vicat VSTB 120 | [° C.] | 153.1 | 148.2 | 145.9 | 153.3 | 148.6 | 145.8 |
| Impact test ISO7391/ | [kJ/m²] | 59 | 66 | 65 | 61 | 66 | 64 |
| 179eU 4 mm RT | | | | | | | |
| Tensile test | | | | | | | |
| Yield stress | [N/mm²] | 102 | 106 | 112 | 101 | 108 | — |
| Elongation | [%] | 3.3 | 3.2 | 3.2 | 3.3 | 3.3 | — |
| Ultimate tensile strength | [N/mm²] | 101 | 106 | 111 | 100 | 108 | 11 |
| Elongation at break | [%] | 3.3 | 3.2 | 3.1 | 3.5 | 3.3 | 3.1 |
| Modulus of elasticity | [N/mm²] | 5972 | 6050 | 6295 | 5834 | 6118 | 6246 |
| UL94V on 1.5 mm | | | | | | | |
| (48 h 23° C.) | | V1 | V1 | V1 | V0 | V1 | V1 |
| Individual assessment | | 3/2/—/— | 3/2/—/— | —/5/—/— | 5/—/—/— | 3/2/—/— | 3/2/—/— |
| V0/V1/V2/Vn.b. | | | | | | | |
| Afterflame time | [s] | 60 | 88 | 80 | 49 | 65 | 77 |
| Afterflame time | [s] | — | — | — | — | — | — |
| (1st application of flame) | | | | | | | |
| 7 d 70° C. | | V1 | V1 | V1 | V1 | V1 | V1 |
| Individual assessment, | | 4/1/—/— | 3/2/—/— | 3/2/—/—- | 1/4/—/— | 4/1/—/— | 3/2/—/— |
| V0/V1/V2/Vn.b | | | | | | | |
| Afterflame time | [s] | 48 | 69 | 72 | 102 | 62 | 79 |
| Afterflame time | [s] | 75 | — | — | — | — | — |
| (1st application of flame) | | | | | | | |
| Overall assessment | | V1 | V1 | V1 | V1 | V1 | V1 |

Vn.b: fail

Table 1b reports important properties regarding Inventive Compositions 8, 9, 11 and 12. Comparative Examples 7V and 10V are presented in juxtaposition. The table reveals that the compositions according to the comparative examples, which do not contain any diglycerol ester, have distinctly worse melt volume flow rates MVR. The flow curves of the inventive compositions exhibit distinctly reduced melt viscosities at each of the various measurement temperatures across the full shear range, indicating an improved flowability.

The inventive compositions surprisingly not only show the appreciable improvement in the rheological properties but also an increase in the modulus of elasticity (stiffness) while retaining the good flammability properties.

TABLE 1c
Inventive compositions comprising glass fibres and FR
additive and Comparative Examples 13V and16V
The melt viscosity values are each reported in the table hereinbelow
together with the shear rates in [1/sec].

| Examples | | 13V | 14 | 15 | 16V | 17 | 18 |
|---|---|---|---|---|---|---|---|
| A-7 | [wt %] | 30.00 | 30.00 | 30.00 | 30.00 | 30.00 | 30.00 |
| A-2 | [wt %] | 50.42 | 50.42 | 50.42 | 50.42 | 50.42 | 50.42 |
| A-6 | [wt %] | 5.55 | 5.35 | 5.15 | 5.54 | 5.34 | 5.14 |
| C-1 | [wt %] | 14.00 | 14.00 | 14.00 | 14.00 | 14.00 | 14.00 |
| D | [wt %] | — | 0.20 | 0.40 | — | 0.20 | 0.40 |
| B | [wt %] | 0.03 | 0.03 | 0.03 | 0.03 | 0.03 | 0.03 |
| F | [wt %] | — | — | — | 0.01 | 0.01 | 0.01 |
| Tests: | | | | | | | |
| MVR | [ml/10 min] | 7.2 | 13.4 | 16.5 | 7.4 | 13.5 | 22.6 |
| IMVR20′ | [ml/10 min] | 7.2 | 13.6 | 16.8 | 7.6 | 14.2 | 24.2 |
| Melt viscosity at 300° C. | | | | | | | |
| eta 50 | [Pas] | 623 | 492 | 371 | 666 | 493 | 370 |
| eta 100 | [Pas] | 577 | 438 | 313 | 568 | 416 | 302 |
| eta 200 | [Pas] | 502 | 378 | 268 | 504 | 354 | 247 |
| eta 500 | [Pas] | 400 | 313 | 231 | 408 | 299 | 207 |
| eta 1000 | [Pas] | 316 | 258 | 197 | 328 | 247 | 176 |
| eta 1500 | [Pas] | 268 | 222 | 173 | 274 | 213 | 157 |
| eta 5000 | [Pas] | 139 | 119 | 102 | 142 | 119 | 94 |
| Melt viscosity at 320° C. | | | | | | | |
| eta 50 | [Pas] | 349 | 286 | 270 | 391 | 355 | 243 |
| eta 100 | [Pas] | 337 | 248 | 222 | 327 | 286 | 197 |
| eta 200 | [Pas] | 297 | 235 | 183 | 293 | 233 | 165 |
| eta 500 | [Pas] | 252 | 198 | 149 | 250 | 194 | 133 |
| eta 1000 | [Pas] | 214 | 165 | 130 | 211 | 166 | 116 |
| eta 1500 | [Pas] | 186 | 146 | 119 | 185 | 148 | 105 |
| eta 5000 | [Pas] | 108 | 88 | 78 | 103 | 95 | 72 |
| Melt viscosity at 340° C. | | | | | | | |
| eta 50 | [Pas] | 169 | 232 | 164 | 278 | 255 | 115 |
| eta 100 | [Pas] | 168 | 186 | 137 | 204 | 207 | 109 |
| eta 200 | [Pas] | 167 | 148 | 114 | 192 | 171 | 99 |
| eta 500 | [Pas] | 147 | 127 | 99 | 162 | 142 | 83 |
| eta 1000 | [Pas] | 125 | 110 | 86 | 140 | 124 | 73 |
| eta 1500 | [Pas] | 112 | 101 | 79 | 127 | 113 | 69 |
| eta 5000 | [Pas] | 78 | 70 | 54 | 83 | 71 | 52 |
| Vicat VSTB 50 | [Pas] | 150.2 | 146.9 | 145.0 | 150.5 | 146.3 | 143.8 |
| UL94V in 3.0 mm | | | | | | | |
| ( 48 h 23° C.) | | V0 | V0 | V0 | V0 | V0 | V0 |
| Individual assessment | | 5/—/—/— | 5/—/—/— | 5/—/—/— | 5/—/—/— | 5/—/—/— | 5/—/—/— |
| V0/V1/V2/Vn.b. | | | | | | | |
| Afterflame time | [s] | 24 | 28 | 29 | 32 | 21 | 41 |
| Afterflame time | [s] | — | — | — | — | — | — |
| (1st application of flame) | | | | | | | |
| ( 7 d 70° C.) | | V0 | V0 | V0 | V0 | V0 | V0 |
| Individual assessment, | | 5/—/—/— | 5/—/—/— | 5/—/—/— | 5/—/—/— | 5/—/—/— | 5/—/—/— |
| V0/V1/V2/Vn.b. | | | | | | | |
| Afterflame time | [s] | 23 | 22 | 33 | 26 | 24 | 22 |
| Afterflame time | [s] | — | — | — | — | — | — |
| (1st application of flame) | | | | | | | |
| Overall evaluation | [s] | V0 | V0 | V0 | V0 | V0 | V0 |

Vn.b: fail

Table 1c reports important properties regarding Inventive Compositions 14, 15, 17 and 18. Comparative Examples 13V and 16V are presented in juxtaposition. The table reveals that the compositions according to the comparative examples, which do not contain any diglycerol ester, have distinctly worse melt volume flow rates MVR. The flow curves of the inventive compositions exhibit distinctly reduced melt viscosities at each of the various measurement temperatures across the full shear range, indicating an improved flowability.

The inventive compositions surprisingly not only show the appreciable improvement in the rheological properties but also good flammability properties.

TABLE 1d
Inventive compositions comprising glass fibres and
FR additive and Comparative Examples 19V and 22V
The melt viscosity values are each reported in the table
hereinbelow together with the shear rates in [1/sec].

| Examples | | 19V | 20 | 21 | 22V | 23 | 24 |
|---|---|---|---|---|---|---|---|
| A-7 | [wt %] | 73.00 | 73.00 | 73.00 | 73.00 | 73.00 | 73.00 |
| A-6 | [wt %] | 4.94 | 4.74 | 4.54 | 4.93 | 4.73 | 4.53 |
| C-7 | [wt %] | 20.00 | 20.00 | 20.00 | 20.00 | 20.00 | 20.00 |
| B | [wt %] | 0.06 | 0.06 | 0.06 | 0.06 | 0.06 | 0.06 |
| G-3 | [wt %] | 2.00 | 2.00 | 2.00 | 2.00 | 2.00 | 2.00 |
| D | [wt %] | — | 0.20 | 0.40 | — | 0.20 | 0.40 |
| F | [wt %] | — | — | — | 0.01 | 0.01 | 0.01 |
| Tests: | | | | | | | |
| MVR | [ml/10 min] | 8.5 | 15.7 | 33.4 | 8.2 | 18.2 | 28.9 |
| IMVR20′ | [ml/10 min] | 8.7 | 16.1 | 32.3 | 8.7 | 18.9 | 28.3 |
| Vicat VSTB50 | [° C.] | 151.8 | 147.6 | 143.7 | 151.4 | 147.9 | 144 |
| Melt viscosity at 300° C. | | | | | | | |
| eta 50 | [Pas] | 462 | 308 | 148 | 508 | 291 | 193 |
| eta 100 | [Pas] | 415 | 255 | 135 | 449 | 260 | 176 |
| eta 200 | [Pas] | 369 | 242 | 124 | 399 | 235 | 157 |
| eta 500 | [Pas] | 302 | 203 | 107 | 320 | 200 | 133 |
| eta 1000 | [Pas] | 236 | 167 | 94 | 250 | 167 | 117 |
| eta 1500 | [Pas] | 201 | 143 | 87 | 213 | 144 | 104 |
| eta 5000 | [Pas] | 108 | 83 | 57 | 117 | 86 | 65 |
| Melt viscosity at 320° C. | | | | | | | |
| eta 50 | [Pas] | 261 | 182 | 97 | 287 | 183 | 130 |
| eta 100 | [Pas] | 247 | 164 | 85 | 266 | 159 | 111 |
| eta 200 | [Pas] | 238 | 149 | 77 | 239 | 39 | 101 |
| eta 500 | [Pas] | 203 | 128 | 67 | 204 | 124 | 88 |
| eta 1000 | [Pas] | 169 | 111 | 60 | 169 | 108 | 77 |
| eta 1500 | [Pas] | 145 | 94 | 56 | 144 | 97 | 71 |
| eta 5000 | [Pas] | 89 | 61 | 40 | 85 | 61 | 47 |
| Melt viscosity at 340° C. | | | | | | | |
| eta 50 | [Pas] | 159 | 99 | 60 | 183 | 120 | 76 |
| eta 100 | [Pas] | 151 | 97 | 56 | 168 | 105 | 71 |
| eta 200 | [Pas] | 138 | 88 | 49 | 156 | 94 | 63 |
| eta 500 | [Pas] | 122 | 80 | 42 | 137 | 83 | 58 |
| eta 1000 | [Pas] | 108 | 72 | 39 | 119 | 74 | 51 |
| eta 1500 | [Pas] | 98 | 66 | 35 | 105 | 68 | 47 |
| eta 5000 | [Pas] | 65 | 45 | 28 | 68 | 46 | 35 |
| UL94V in 1.0 mm | | | | | | | |
| (48 h 23° C.) | | V1 | V2 | V2 | V2 | V1 | V2 |
| Individual assessment | | 4/1/—/— | 3/—/2/— | 2/1/2/— | 3/1/1/— | 3/2/—/— | —/—/5/— |
| V0/V1/V2/Vn.b. | | | | | | | |
| Afterflame time | [s] | 73 | 61 | 55 | 81 | 97 | 72 |
| Afterflame time | [s] | 118 | — | — | <115 | — | — |
| (1st application of flame) | | | | | | | |
| (7 d 70° C.) | | V2 | V2 | V2 | V2 | V2 | V2 |
| Individual assessment, | | 3/—/2/— | 1/2/2/— | 1/—/4/— | —/3/2/— | 1/—/4/— | —/—/5/— |
| V0/V1/V2/Vn.b | | | | | | | |
| Afterflame time | [s] | 67 | 92 | 63 | 118 | 54 | 75 |
| Afterflame time | [s] | — | — | — | — | — | — |
| (1st application of flame) | | | | | | | |
| Overall evaluation evaluation | | V2 | V2 | V2 | V2 | V2 | V2 |

Vn.b: fail

Table 1d reports important properties regarding Inventive Compositions 20, 21, 23 and 24. Comparative Examples 19V and 22V are presented in juxtaposition. The table reveals that the compositions according to the comparative examples, which do not contain any diglycerol ester, have distinctly worse melt volume flow rates MVR. The flow curves of the inventive compositions exhibit distinctly reduced melt viscosities at each of the various measurement temperatures across the full shear range, indicating an improved flowability.

TABLE 1e
Inventive compositions comprising glass fibres
and Comparative Examples 25V and 28V
The melt viscosity values are each reported in the table
hereinbelow together with the shear rates in [1/sec].

| Example | | 25V | 26 | 27 | 28V | 29 | 30 |
|---|---|---|---|---|---|---|---|
| A-3 | [wt %] | 63.00 | 63.00 | 63.00 | 63.00 | 63.00 | 63.00 |
| A-2 | [wt %] | 7.00 | 6.80 | 6.60 | 6.99 | 6.79 | 6.59 |
| C-8 | [wt %] | 30.00 | 30.00 | 30.00 | 30.00 | 30.00 | 30.00 |
| D | [wt %] | — | 0.20 | 0.40 | — | 0.20 | 0.40 |
| F | [wt %] | — | — | — | 0.01 | 0.01 | 0.01 |
| Tests | | | | | | | |
| MVR 300° C./1.2 kg | [cm³/10 min] | 4.5 | 9.1 | 15.3 | 4.5 | 8.8 | 15.3 |
| IMVR20′ 300° C./1.2 kg | [cm³/10 min] | 5.1 | 104 | 19.9 | 5.6 | 10.9 | 19.0 |
| Melt viscosity at 300° C. | | | | | | | |
| eta 50 | [Pas] | 763 | 532 | 376 | 721 | 540 | 420 |
| eta 100 | [Pas] | 669 | 483 | 340 | 677 | 455 | 367 |
| eta 200 | [Pas] | 581 | 430 | 301 | 591 | 377 | 324 |
| eta 500 | [Pas] | 452 | 346 | 249 | 460 | 302 | 266 |
| eta 1000 | [Pas] | 346 | 274 | 205 | 348 | 258 | 218 |
| eta 1500 | [Pas] | 294 | 235 | 174 | 303 | 222 | 189 |
| eta 5000 | [Pas] | 154 | 129 | 104 | 158 | 132 | 113 |
| Melt viscosity at 320° C. | | | | | | | |
| eta 50 | [Pas] | 397 | 278 | 133 | 372 | 299 | 220 |
| eta 100 | [Pas] | 60 | 237 | 128 | 365 | 255 | 180 |
| eta 200 | [Pas] | 321 | 209 | 114 | 325 | 228 | 165 |
| eta 500 | [Pas] | 265 | 176 | 95 | 250 | 199 | 132 |
| eta 1000 | [Pas] | 221 | 154 | 83 | 206 | 167 | 110 |
| eta 1500 | [Pas] | 190 | 139 | 75 | 170 | 149 | 95 |
| eta 5000 | [Pas] | 110 | 88 | 55 | 100 | 93 | 68 |
| Melt viscosity at 340° C. | | | | | | | |
| eta 50 | [Pas] | 178 | 114 | 84 | 215 | 120 | 104 |
| eta 100 | [Pas] | 168 | 106 | 72 | 187 | 115 | 92 |
| eta 200 | [Pas] | 153 | 95 | 65 | 159 | 105 | 82 |
| eta 500 | [Pas] | 131 | 84 | 57 | 141 | 92 | 66 |
| eta 1000 | [Pas] | 118 | 76 | 51 | 117 | 89 | 57 |
| eta 1500 | [Pas] | 112 | 71 | 48 | 113 | 83 | 52 |
| eta 5000 | [Pas] | 75 | 55 | 35 | 73 | 65 | 42 |

Table 1e reports important properties regarding Inventive Compositions 26, 27, 29 and 30. Comparative Examples 25V and 28V are presented in juxtaposition. The table reveals that the compositions according to the comparative examples, which do not contain any diglycerol ester, have distinctly worse melt volume flow rates MVR. The flow curves of the inventive compositions exhibit distinctly reduced melt viscosities at each of the various measurement temperatures across the full shear range, indicating an improved flowability.

TABLE 1f
Inventive compositions comprising glass fibres
and Comparative Examples 31V and 34V
The melt viscosity values are each reported in the table
hereinbelow together with the shear rates in [1/sec].

| Examples | | 31V | 32 | 33 | 34V | 35 | 36 |
|---|---|---|---|---|---|---|---|
| A-3 | [wt %] | 63.00 | 63.00 | 63.00 | 63.00 | 63.00 | 63.00 |
| A-2 | [wt %] | 7.00 | 6.80 | 6.60 | 6.99 | 6.79 | 6.59 |
| C-9 | [wt %] | 30.00 | 30.00 | 30.00 | 30.00 | 30.00 | 30.00 |
| D | [wt %] | — | 0.20 | 0.40 | — | 0.20 | 0.40 |
| F | [wt %] | — | — | — | 0.01 | 0.01 | 0.01 |
| Tests | | | | | | | |
| MVR 300° C./1.2 kg | [cm³/10 min] | 5.3 | 10.0 | 19.4 | 5.5 | 9.9 | 19.8 |
| IMVR20′ 300° C./1.2 kg | [cm³/10 min] | 5.9 | 13.4 | 24.3 | 5.8 | 12.6 | 24.8 |
| Melt viscosity at 300° C. | | | | | | | |
| eta 5 | [Pas] | 699 | 586 | 436 | 630 | 534 | 397 |
| eta 100 | [Pas] | 633 | 531 | 390 | 628 | 523 | 390 |
| eta 200 | [Pas] | 580 | 483 | 361 | 579 | 486 | 369 |
| eta 500 | [Pas] | 480 | 408 | 313 | 479 | 411 | 307 |
| eta 1000 | [Pas] | 384 | 334 | 263 | 381 | 336 | 264 |
| eta 1500 | [Pas] | 317 | 282 | 230 | 318 | 284 | 227 |
| ets 5000 | [Pas] | 157 | 145 | 125 | 15 | 147 | 122 |
| Melt viscosity at 320° C. | | | | | | | |
| eta 50 | [Pas] | 328 | 250 | 175 | 260 | 281 | 200 |
| ets 100 | [Pas] | 305 | 237 | 172 | 255 | 267 | 191 |
| eta 200 | [Pas] | 282 | 233 | 161 | 250 | 254 | 182 |
| eta 500 | [Pas] | 250 | 212 | 152 | 237 | 230 | 169 |
| eta 1000 | [Pas] | 217 | 186 | 138 | 211 | 201 | 153 |
| eta 1500 | [Pas] | 193 | 167 | 124 | 192 | 180 | 142 |
| eta 5000 | [Pas] | 111 | 104 | 81 | 116 | 116 | 91 |
| Melt viscosity at 340° C. | | | | | | | |
| eta 50 | [Pas] | 142 | 105 | 69 | 174 | 147 | 90 |
| eta 100 | [Pas] | 137 | 102 | 66 | 173 | 140 | 87 |
| esa 200 | [Pas] | 133 | 99 | 62 | 166 | 137 | 84 |
| eta 500 | [Pas] | 128 | 96 | 60 | 156 | 120 | 82 |
| eta 1000 | [Pas] | 119 | 93 | 56 | 142 | 105 | 79 |
| eta 1500 | [Pas] | 112 | 88 | 56 | 132 | 95 | 77 |
| eta 5000 | [Pas] | 77 | 65 | 46 | 85 | 69 | 58 |

Table 1f reports important properties regarding Inventive Compositions 32, 33, 35 and 36. Comparative Examples 31V and 34V are presented in juxtaposition. The table reveals that the compositions according to the comparative examples, which do not contain any diglycerol ester, have distinctly worse melt volume flow rates MVR. The flow curves of the inventive compositions exhibit distinctly reduced melt viscosities at each of the various measurement temperatures across the full shear range, indicating an improved flowability.

TABLE 1g
Inventive compositions comprising glass fibres and Comparative Example 37V

| Composition | | 37V | 38 | 39 | 40 | 41 | 42 | 43 |
|---|---|---|---|---|---|---|---|---|
| A-1 | [wt %] | 79.35 | 79.35 | 79.35 | 74.35 | 74.35 | 69.35 | 69.35 |
| A-4 | [wt %] | 3.65 | 3.65 | 3.65 | 3.65 | 3.65 | 3.65 | 3.65 |
| A-2 | [wt %] | 5.85 | 6.1 | 5.9 | 6.1 | 5.9 | 6.1 | 5.9 |
| G-2 | [wt %] | 0.45 | — | — | — | — | — | — |
| D | [wt %] | — | 0.2 | 0.4 | 0.2 | 0.4 | 0.2 | 0.4 |
| Blendex 449 | [wt %] | 0.2 | 0.2 | 0.2 | 0.2 | 0.2 | 0.2 | 0.2 |
| E | [wt %] | 0.5 | 0.5 | 0.5 | 0.5 | 0.5 | 0.5 | 0.5 |
| C-1 | [wt %] | 10 | 10 | 10 | 15 | 15 | 20 | 20 |
| Tests: | | | | | | | | |
| MVR | [cm³/10 min] | 5.7 | 10.4 | 16.6 | 8.1 | 11.9 | 6.6 | 11.9 |
| IMVR20′ | [cm³/10 min] | 5.8 | 1.1 | 17.3 | 8.4 | 12.3 | 7.2 | 11.0 |
| Delta MVR/IMVR20′ | | 0.1 | 0.7 | 0.7 | 0.3 | 0.4 | 0.6 | −0.9 |
| KET | [° C.] | 137 | 137 | 133 | 137 | 132 | 136 | 133 |
| UL 94-5V in 3.0 mm | | | | | | | | |
| Bar testing | | yes | yes | yes | yes | yes | yes | yes |
| Sheet testing | | passed | passed | passed | passed | passed | passed | passed |
| Classification | | 94-5VA | 94-5VA | 94-5VA | 94-5VA | 94-5VA | 94-5VA | 945VA |
| UL94-5V in 2.0 mm | | | | | | | | |
| Bar testing | | yes | yes | yes | yes | yes | yes | yes |
| Sheet testing | | no | no | no | passed | passed | passed | passed |
| Classification | | 94-5VB | 94-5VB | 94-5VB | 94-5VA | 94-5VA | 94-5VA | 94-5VA |
| UL94-5V in 1.5 mm | | | | | | | | |
| Bar testing | | yes | no | no | no | yes | yes | no |
| Sheet testing | | no | — | — | — | no | passed | — |
| Classification | | 94-5VB | — | — | — | 94-5VB | 94-5VA | — |

Table 1g reports important properties regarding Inventive Compositions 38 to 43. Comparative Example 37V is presented in juxtaposition. The table reveals that the composition according to the comparative example, which does not contain any diglycerol ester, has a distinctly worse melt volume flow rate MVR.

Example 41 shows that the UL 94-5V classification in the fire test is retained despite the improved flow rate. Example 42 shows that for an approximately unchanged MVR an even higher rating is achievable in the 94-5V test (from 5VB to 5VA at 1.5 mm)

TABLE 2a
Inventive compositions comprising carbon fibres and Comparative Example 44 V
The melt viscosity values are each reported in the table
hereinbelow together with the shear rates in [1/sec].

| Example | | 44 V | 45 | 46 | 47 |
|---|---|---|---|---|---|
| A-3 | [wt %] | 81 .00 | 81.00 | 81.00 | 81.00 |
| A-2 | [wt %] | 7.00 | 6.79 | 6.69 | 6.59 |
| C-3 | [wt %] | 12.00 | 12.00 | 12.00 | 12.00 |
| D | [wt %] | — | 0.20 | 0.30 | 0.40 |
| F | [wt %] | — | 0.01 | 0.01 | 0.01 |
| Results | | | | | |
| MVR | [cm³/10 min] | 7.0 | 8.6 | 11.7 | 20.5 |
| IMVR20′ | [cm³/10 min] | 7.6 | 9.9 | 16.9 | 24.1 |
| Melt viscosity | | | | | |
| at 300° C. | | | | | |
| eta 50 | [Pas] | 535 | 492 | 468 | 401 |
| eta 100 | [Pas] | 497 | 466 | 441 | 379 |
| eta 200 | [Pas] | 452 | 423 | 401 | 343 |
| eta 500 | [Pas] | 365 | 346 | 327 | 287 |
| eta 1000 | [Pas] | 292 | 278 | 264 | 233 |
| eta 1500 | [Pas] | 253 | 241 | 226 | 203 |
| eta 5000 | [Pas] | 138 | 130 | 124 | 116 |
| Melt viscosity | | | | | |
| at 320° C. | | | | | |
| eta 50 | [Pas] | 254 | 236 | 240 | 216 |
| eta 100 | [Pas] | 250 | 227 | 235 | 200 |
| eta 200 | [Pas] | 249 | 225 | 221 | 199 |
| eta 500 | [Pas] | 217 | 198 | 192 | 176 |
| eta 1000 | [Pas] | 184 | 167 | 163 | 154 |
| eta 1500 | [Pas] | 162 | 147 | 143 | 134 |
| eta 5000 | [Pas] | 100 | 93 | 91 | 87 |
| Melt viscosity | | | | | |
| at 340° C. | | | | | |
| eta 50 | [Pas] | 149 | 118 | 109 | 101 |
| eta 100 | [Pas] | 146 | 115 | 107 | 99 |
| eta 200 | [Pas] | 139 | 114 | 105 | 96 |
| eta 500 | [Pas] | 126 | 113 | 103 | 88 |
| eta 1000 | [Pas] | 107 | 102 | 99 | 77 |
| eta 1500 | [Pas] | 102 | 93 | 90 | 72 |
| eta 5000 | [Pas] | 70 | 64 | 64 | 50 |

Table 2a reports important properties regarding Inventive Compositions 45 to 47. Comparative Example 44V is presented in juxtaposition. The table reveals that the compositions according to the comparative example, which does not contain any diglycerol ester, has distinctly worse melt volume flow rates MVR. The flow curves of the inventive compositions exhibit distinctly reduced melt viscosities at each of the various measurement temperatures across the full shear range, indicating an improved flowability.

TABLE 2b
Inventive compositions comprising carbon fibres
and Comparative Examples 48V and 52V
The melt viscosity values are each reported in the table
hereinbelow together with the shear rates in [1/sec].

| Recipe | | 48V | 49 | 50 | 51 | 52V | 53 | 54 | 55 |
|---|---|---|---|---|---|---|---|---|---|
| A-3 | [wt %] | 81.00 | 81.00 | 81.00 | 81.00 | 81.00 | 81.00 | 81.00 | 81.00 |
| A-2 | [wt %] | 7.00 | 6.79 | 6.69 | 6.59 | 7.00 | 6.79 | 6.69 | 6.59 |
| C-5 | [wt %] | 12.00 | 12.00 | 12.00 | 12.00 | — | — | — | — |
| C-6 | [wt %] | — | — | — | — | 12.00 | 12.00 | 12.00 | 12.00 |
| D | [wt %] | — | 0.20 | 0.30 | 0.40 | — | 0.20 | 0.30 | 0.40 |
| F | [wt %] | — | 0.01 | 0.01 | 0.01 | — | 0.01 | 0.01 | 0.01 |
| Tests: | | | | | | | | | |
| MVR | [cm³/10 min] | 6.8 | 10.6 | 12.6 | 18.3 | 6.3 | 7.9 | 9.1 | 10.4 |
| IMVR20′ | [cm³/10 min] | 7.5 | 13.2 | 17.4 | 25.8 | 7.0 | 10.4 | 11.1 | 13.6 |
| Melt viscosity | | | | | | | | | |
| at 300° C. | | | | | | | | | |
| eta 50 | [Pas] | 456 | 366 | 349 | 302 | 513 | 456 | 453 | 452 |
| eta 100 | [Pas] | 424 | 350 | 329 | 284 | 512 | 446 | 427 | 423 |
| eta 200 | [Pas] | 388 | 322 | 303 | 270 | 458 | 411 | 391 | 386 |
| eta 500 | [Pas] | 330 | 275 | 263 | 236 | 376 | 339 | 324 | 320 |
| eta 1000 | [Pas] | 269 | 226 | 222 | 197 | 299 | 275 | 263 | 257 |
| eta 1500 | [Pas] | 233 | 197 | 196 | 173 | 257 | 239 | 228 | 223 |
| eta 5000 | [Pas] | 126 | 111 | 111 | 103 | 135 | 126 | 123 | 121 |
| Melt viscosity | | | | | | | | | |
| at 320° C. | | | | | | | | | |
| eta 50 | [Pas] | 236 | 164 | 146 | 90 | 350 | 252 | 243 | 225 |
| eta 100 | [Pas] | 217 | 158 | 150 | 88 | 326 | 240 | 229 | 218 |
| eta 200 | [Pas] | 193 | 151 | 141 | 86 | 322 | 241 | 225 | 198 |
| eta 500 | [Pas] | 165 | 135 | 134 | 85 | 270 | 211 | 198 | 175 |
| eta 1000 | [Pas] | 145 | 122 | 121 | 78 | 224 | 180 | 171 | 157 |
| eta 1500 | [Pas] | 126 | 110 | 109 | 76 | 192 | 161 | 154 | 135 |
| eta 5000 | [Pas] | 85 | 74 | 74 | 54 | 110 | 97 | 93 | 85 |
| Melt viscosity | | | | | | | | | |
| at 340° C. | | | | | | | | | |
| eta 50 | [Pas] | 102 | 56 | 67 | 38 | 163 | 145 | 122 | 134 |
| eta 100 | [Pas] | 101 | 55 | 66 | 37 | 162 | 143 | 117 | 126 |
| eta 200 | [Pas] | 99 | 53 | 61 | 35 | 161 | 138 | 113 | 121 |
| eta 500 | [Pas] | 92 | 52 | 55 | 34 | 136 | 127 | 112 | 110 |
| eta 1000 | [Pas] | 85 | 49 | 50 | 33 | 124 | 115 | 104 | 97 |
| eta 1500 | [Pas] | 81 | 48 | 48 | 32 | 111 | 106 | 95 | 85 |
| eta 5000 | [Pas] | 58 | 38 | 37 | 25 | 75 | 70 | 63 | 62 |

Table 2b reports important properties regarding Inventive Compositions 49 to 51 and 53 to 55. Comparative Examples 48V and 52V are presented in juxtaposition. The table reveals that the compositions according to the comparative examples, which do not contain any diglycerol ester, have distinctly worse melt volume flow rates MVR. The flow curves of the inventive compositions exhibit distinctly reduced melt viscosities at each of the various measurement temperatures across the full shear range, indicating an improved flowability.

TABLE 3a
Inventive compositions comprising carbon nanotubes and Comparative Examples 56V to 63V

| Example | | 56V | 57V | 58V | 59V | 60V | 61V | 62V | 63V | 64 | 65 | 66 |
|---|---|---|---|---|---|---|---|---|---|---|---|---|
| A-3 | [wt %] | 90.00 | 90.00 | 90.00 | 90.00 | 90.00 | 90.00 | 90.00 | 90.00 | 90.00 | 90.00 | 90.00 |
| A-2 | [wt %] | 10.00 | 8.00 | 7.80 | 7.60 | 7.40 | 7.80 | 7.60 | 7.40 | 7.80 | 7.60 | 7.40 |
| G-1 | [wt %] | — | — | 0.20 | 0.40 | 0.60 | — | — | — | — | — | — |
| G-2 | [wt %] | — | — | — | — | — | 0.20 | 0.40 | 0.60 | — | — | — |
| D | [wt %] | — | — | — | — | — | — | — | — | 0.20 | 0.40 | 0.60 |
| C-4 | [wt %] | — | 2.00 | 2.00 | 2.00 | 2.00 | 2.00 | 2.00 | 2.00 | 2.00 | 2.00 | 2.00 |
| Tests: | | | | | | | | | | | | |
| MVR | [cm³/10 min] | 10.6 | 4.2 | 6.1 | 8.6 | 11.6 | 4.3 | 4.7 | 5.3 | 9.6 | 11.8 | 26.1 |
| IMVR20′ | [cm³/10 min] | 10 | 4.1 | 6.4 | 10.1 | 14.3 | 4.3 | 5 | 5.4 | 10.2 | 13.5 | 27.2 |
| Vicat VSTB50 | [° C.] | 147.2 | 148.2 | 145 | 142.9 | 140.6 | 146.5 | 145.2 | 143.6 | 145.2 | 142.9 | 139.4 |

Table 3a reports important properties regarding Inventive Compositions 64 to 66. Comparative Examples 56V to 63V are presented in juxtaposition. The table reveals that the compositions according to the comparative examples, which do not contain any diglycerol ester, have distinctly worse melt volume flow rates MVR.

TABLE 3b
Inventive compositions comprising carbon nanotubes
and Comparative Examples 67V to 74V

| Example | | 67V | 68V | 69V | 70V | 71V | 72V | 73V | 74V | 75 | 76 | 77 |
|---|---|---|---|---|---|---|---|---|---|---|---|---|
| A-3 | [wt %] | 90.00 | 90.00 | 90.00 | 90.00 | 90.00 | 90.00 | 90.00 | 90.00 | 90.00 | 90.00 | 90.00 |
| A-2 | [wt %] | 10.00 | 7.00 | 6.80 | 6.60 | 6.40 | 6.80 | 6.60 | 6.40 | 6.80 | 6.60 | 6.40 |
| G-1 | [wt %] | — | — | 0.20 | 0.40 | 0.60 | — | — | — | — | — | — |
| G-2 | [wt %] | — | — | — | — | — | 0.20 | 0.40 | 0.60 | — | — | — |
| D | [wt %] | — | — | — | — | — | — | — | — | 0.20 | 0.40 | 0.60 |
| C-4 | [wt %] | 3.00 | 3.00 | 3.00 | 3.00 | 3.00 | 3.00 | 3.00 | 3.00 | 3.00 | 3.00 | 3.00 |
| Tests: | | | | | | | | | | | | |
| MVR | [cm³/10 min] | 10.2 | 2.2 | 3.7 | 5.7 | 8.2 | 2.5 | 2.8 | 3.2 | 4.9 | 15.7 | 17.7 |
| IMVR20′ | [cm³/10 min] | 10.2 | 2.3 | 4.0 | 6.9 | 10.1 | 2.7 | 2.9 | 3.1 | 5.4 | 14.2 | 19.3 |
| Delta MVR/ | | 0.0 | 0.1 | 0.3 | 1.2 | 1.9 | 0.2 | 0.1 | −0.1 | 0.5 | −1.5 | 1.6 |
| IMVR20′ | | | | | | | | | | | | |
| Vicat VSTB50 | [° C.] | 147.5 | 148.8 | 145.9 | 143.3 | 140.5 | 146.9 | 145.6 | 143.5 | 145.2 | 142.7 | 139.6 |

Table 3b reports important properties regarding Inventive Compositions 75 to 77. Comparative Examples 67V to 74V are presented in juxtaposition. The table reveals that the compositions according to the comparative examples, which do not contain any diglycerol ester, have distinctly worse melt volume flow rates MVR.

TABLE 3c
Inventive compositions comprising carbon
nanotubes and Comparative Examples 78V to 83V

| Example | | 78V | 79V | 80V | 81V | 82V | 83V | 84 |
|---|---|---|---|---|---|---|---|---|
| A-3 | [wt %] | 90.00 | 90.00 | 90.00 | 90.00 | 90.00 | 90.00 | 90.00 |
| A-2 | [wt %] | 10.00 | 6.00 | 5.40 | 5.80 | 5.60 | 5.40 | 5.40 |
| G-1 | [wt %] | — | — | 0.60 | — | — | — | — |
| G-2 | [wt %] | — | — | — | 0.20 | 0.40 | 0.60 | — |
| D | [wt %] | — | — | — | — | — | — | 0.60 |
| C-4 | [wt %] | — | 4.00 | 4.00 | 4.00 | 4.00 | 4.00 | 4.00 |
| Tests: | | | | | | | | |
| MVR | [cm³/10 min] | 10.1 | 0.9 | 4.5 | 0.7 | 1.6 | 1.7 | 11.7 |
| IMVR20′ | [cm³/10 min] | 10.0 | 0.9 | 5.3 | 0.8 | 1.7 | 1.7 | 11.6 |
| Vicat VSTB50 | [° C.] | 146.8 | 148.3 | 140.3 | 147.1 | 145.3 | 144 | 140.5 |

Table 3c reports important properties regarding Inventive Composition 84. Comparative Examples 78V to 83V, in particular 80V and 83V, are presented in juxtaposition. The table reveals that the compositions according to the comparative examples, which do not contain any diglycerol ester, have distinctly worse melt volume flow rates MVR.

1.-15. (canceled)

16. A composition comprising
A) 20 wt % to 99.0 wt % of an aromatic polycarbonate,
B) 0.0 to 1.0 wt % of at least one flame retardant,
C) 0.5 wt % to 50.0 wt % of at least one glass fibre, one carbon fibre and/or carbon nanotubes,
D) 0.01 wt % to 3.0 wt % of at least one flow auxiliary selected from the group of diglycerol esters,
E) 0.0 wt % to 5.0 wt % of at least one antidripping agent,
F) 0.0 wt % to 1.0 wt % of at least one thermal stabilizer,
G) 0.0 wt % to 10.0 wt % of further additives.

17. The composition according to claim 16, wherein the components A) to G) add up to 100 wt %.

18. The composition according to claim 16, wherein the diglycerol ester content is an ester of formula (I) 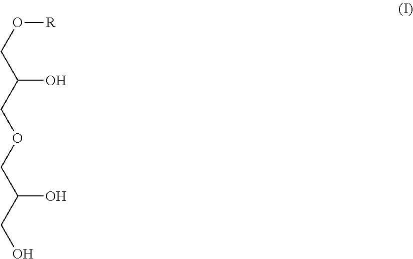
where R=COCₙH₂ₙ₊₁ and/or R═COR′,
where n is an integer and where R′ is a branched alkyl moiety or a branched or unbranched alkenyl moiety and CₙH₂ₙ₊₁ is an aliphatic, saturated linear alkyl moiety.

19. The composition according to claim 18, wherein R=COCₙH₂ₙ₊₁, where n is an integer from 6-24.

20. The composition according to claim 16, wherein the flame retardant present is an alkali and/or alkaline earth metal salt of an aliphatic/aromatic sulphonic acid or of a sulphonamide.

21. The composition according to claim 16, wherein at least 0.05 wt % of an antidripping agent is present.

22. The composition according to claim 16, comprising glass fibres and from 0.001 to 1.0 wt % of a flame retardant.

23. The composition according to claim 16, wherein glass fibres are present and the glass fibres have a precompounding length of 3 mm to 6 mm.

24. The composition according to claim 16, wherein glass fibres are present and the glass fibres are chopped glass fibres.

25. The composition according to claim 16, wherein glass fibres are present and the glass fibres have a mean fibre diameter of 5 to 25 μm.

26. The composition according to claim 16, wherein the composition has a melt volume flow rate MVR of 7-25 cm³/10 min, determined to ISO 1133 (test temperature 300° C., mass 1.2 kg) and the modulus of elasticity, determined to ISO 527, is at least 2700 kg*m⁻¹*s⁻².

27. The composition according to claim 16, wherein the composition comprises carbon fibres.

28. A method comprising utilizing the composition according to claim 16 in the manufacture of thin walled shaped articles 0.1-3 mm in thickness for the electrical/electronics sector or the IT sector with a UL94 V-0 flammability rating at 1.5 mm wall thickness.

29. A method comprising utilizing the composition according to claim 16 with a melt volume flow rate MVR of 1-30 cm³/10 min, determined to ISO 1133 (test temperature 300° C., mass 1.2 kg) and a Charpy impact strength, determined to DIN EN ISO 179/1 eU at room temperature, of above 35 kJ/m² in the manufacture of shaped articles.

30. A method comprising utilizing a diglycerol ester to improve the flowability of polycarbonate melts.

1. Composition comprising
A) 20 wt % to 99.0 wt % of an aromatic polycarbonate,
B) 0.0 to 1.0 wt % of at least one flame retardant,
C) 0.5 wt % to 50.0 wt % of at least one glass fibre, one carbon fibre and/or carbon nanotubes,
D) 0.01 wt % to 3.0 wt % of at least one flow auxiliary selected from the group of diglycerol esters,
E) 0.0 wt % to 5.0 wt % of at least one antidripping agent,
F) 0.0 wt % to 1.0 wt % of at least one thermal stabilizer,
G) 0.0 wt % to 10.0 wt % of further additives.

2. Composition according to claim 1, characterized in that the components A) to G) add up to 100 wt %.

3. Composition according to claim 1 or 2, characterized in that the diglycerol ester content is an ester of formula (I) 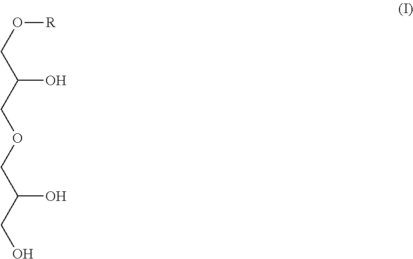
where R=COCₙH₂ₙ₊₁ and/or R═COR′,
where n is an integer and where R′ is a branched alkyl moiety or a branched or unbranched alkenyl moiety and CₙH₂ₙ₊₁ is an aliphatic, saturated linear alkyl moiety.

4. Composition according to claim 3, characterized in that R=COCₙH₂ₙ₊₁, where n is an integer from 6-24, preferably from 8 to 18, more preferably from 10 to 16 and yet more preferably 12.

5. Composition according to any preceding claim, characterized in that the flame retardant present is an alkali and/or alkaline earth metal salt of an aliphatic/aromatic sulphonic acid or of a sulphonamide.

6. Composition according to any preceding claim, characterized in that at least 0.05 wt % of an antidripping agent is present.

7. Composition according to any preceding claim, comprising glass fibres and from 0.001 to 1.0 wt % of a flame retardant.

8. Composition according to any preceding claim, characterized in that glass fibres are present and the glass fibres have a precompounding length of 3 mm to 6 mm.

9. Composition according to any preceding claim, characterized in that glass fibres are present and the glass fibres are chopped glass fibres.

10. Composition according to any of claims 1 to 9, characterized in that glass fibres are present and the glass fibres have a mean fibre diameter of 5 to 25 μm, preferably of 8 to 20 μm and more preferably of 11 to 17 μm.

11. Composition according to any preceding claim, characterized in that the composition has a melt volume flow rate MVR of 7-25 cm³/10 min, determined to ISO 1133 (test temperature 300° C., mass 1.2 kg) and the modulus of elasticity, determined to ISO 527, is at least 2700 kg*m⁻¹*s⁻².

12. Composition according to any of claims 1 to 7, characterized in that the composition comprises carbon fibres.

13. Use of a composition according to any of claims 1 to 12 in the manufacture of thin walled shaped articles 0.1-3 mm in thickness for the electrical/electronics sector or the IT sector with a UL94 V-0 flammability rating at 1.5 mm wall thickness.

14. Use of the composition according to any of claims 1 to 12 with a melt volume flow rate MVR of 1-30 cm³/10 min, determined to ISO 1133 (test temperature 300° C., mass 1.2 kg) and a Charpy impact strength, determined to DIN EN ISO 179/1 eU at room temperature, of above 35 kJ/m² in the manufacture of shaped articles, specifically for component parts for Ultrabooks.

15. Use of diglycerol esters to improve the flowability of polycarbonate melts.
